(19) United States
(12) Patent Application Publication
(10) Pub. No.: US 2025/0197767 A1
(43) Pub. Date: Jun. 19, 2025

(54) LIQUID DETERGENT COMPOSITIONS AND METHODS OF USING THE SAME

(71) Applicant: HENKEL AG & CO. KGAA, Düsseldorf (DE)

(72) Inventors: Daniel PIORKOWSKI, Fairfield, CT (US); Janet COOPE-EPSTEIN, Trumbull, CT (US)

(21) Appl. No.: 18/970,733

(22) Filed: Dec. 5, 2024

Related U.S. Application Data
(60) Provisional application No. 63/611,951, filed on Dec. 19, 2023.

(51) Int. Cl. C11D 1/83; C11D 1/14; C11D 1/72; C11D 3/00; C11D 3/04; C11D 3/10; C11D 3/30; C11D 3/33; C11D 3/37; C11D 3/386; C11D 3/40; C11D 3/48

(52) U.S. Cl. CPC C11D 1/83; C11D 3/0026; C11D 3/0036; C11D 3/046; C11D 3/10; C11D 3/30; C11D 3/33; C11D 3/3765; C11D 3/38618; C11D 3/38636; C11D 3/40; C11D 3/48; C11D 1/146; C11D 1/72

(57) ABSTRACT

Disclosed are detergent compositions comprising sugar amines, fatty alcohol ethoxylates, anionic surfactants and water. Also disclosed are detergent compositions comprising sugar amines, mixtures of nonionic and anionic surfactants, and water.

### CROSS REFERENCE TO RELATED APPLICATIONS

This application claims the benefit of U.S. Provisional Patent App. No. 63/611,951, filed Dec. 19, 2023, the disclosure of which is hereby incorporated by reference herein.

### FIELD OF THE INVENTION

This disclosure generally relates to liquid detergent compositions and methods of using the same. More specifically, this disclosure generally relates to liquid detergent compositions containing sugar amines.

### BACKGROUND

Liquid laundry detergent compositions contain surfactants to have good cleaning performance. However, many surfactant compositions cause skin and eye irritation. Consumers generally prefer mild liquid detergent formulations. While several products currently on the market claim to be mild, there is a still a need to develop improved mild liquid detergent formulations that have good cleaning performance.

### SUMMARY OF THE INVENTION

Various aspects of the present disclosure are directed to liquid detergent compositions and methods of using the same.

In some instances, a first aspect of the disclosure can be described as a liquid detergent composition comprising, consisting essentially of, or consisting of a sugar amine, a fatty alcohol ethoxylate, an anionic surfactant and water.

In some instances, a second aspect of the disclosure can be described as a liquid detergent composition according to the first aspect, wherein the sugar amine is in an amount ranging from about 0.01 to about 2 wt % of the detergent composition, the fatty alcohol ethoxylate is in an amount ranging from about 5 to about 30 wt % of the detergent composition, and the anionic surfactant in an amount ranging from about 5 to about 35 wt % of the detergent composition.

In some instances, a third aspect of the disclosure can be described as a liquid detergent composition according to the first or second aspect, wherein the sugar amine is a sugar alcohol amine, sugar diamine, a salt thereof, or any combination of any of the foregoing.

In some instances, a fourth aspect of the disclosure can be described as a liquid detergent composition according to any one of the first through third aspects, wherein sugar amine is sorbitol amine, glucosamine, a glucose diamine, a salt thereof, or any combination of any of the foregoing.

In some instances, a fifth aspect of the disclosure can be described as a liquid detergent composition according to any one of the first, second or fourth aspects, wherein sugar amine is glucosamine HCl.

In some instances, a sixth aspect of the disclosure can be described as a liquid detergent composition according to any one of the first through fifth aspects, wherein the liquid detergent further includes a tetraborate salt. In some instances, the tetraborate salt is sodium tetraborate.

In some instances, a seventh aspect of the disclosure can be described as a liquid detergent composition according to any one of the first through sixth aspects, wherein the fatty alcohol ethoxylate is laureth-6 ethylene oxide (EO).

In some instances, an eighth aspect of the disclosure can be described as a liquid detergent composition according to any one of the first through seventh aspects, wherein the liquid detergent further includes a strong base. In some instances, the strong base is NaOH.

In some instances, a ninth aspect of the disclosure can be described as a liquid detergent composition according to any one of the first through eighth aspects, wherein the liquid detergent further includes a weak acid. In some instances, the weak acid is citric acid.

In some instances, a tenth aspect of the disclosure can be described as a liquid detergent composition according to any one of the first through ninth aspects, wherein the pH of the detergent composition ranges from about 7 to about 9.

In some instances, an eleventh aspect of the disclosure can be described as a liquid detergent composition according to any one of the first through ninth aspects, wherein the pH of the detergent composition ranges from about 9 to about 12.

In some instances, a twelfth aspect of the disclosure can be described as a liquid detergent composition according to any one of the first through eleventh aspects, wherein the anionic surfactant is a lauryl sulfate.

In some instances, a thirteenth aspect of the disclosure can be described as a liquid detergent composition according to any one of the first through eleventh aspects, wherein the anionic surfactant is a lauryl ether sulfate (also commonly referred to as a laureth sulfate).

In some instances, a fourteenth aspect of the disclosure can be described as a liquid detergent composition according to any one of the first through thirteenth aspects, wherein the liquid detergent further includes a fatty acid. In some instances, the fatty acid can be present in an amount ranging from about 0.1 to about 1 wt % of the detergent composition.

In some instances, a fifteenth aspect of the disclosure can be described as a liquid detergent composition according to any one of the first through fourteenth aspects, wherein the liquid detergent further includes an anti-redeposition polymer. In some instances, the anti-redeposition polymer can be present in an amount ranging from about 0.1 to about 1 wt % of the detergent composition. In some instances, the anti-redeposition polymer is a copolymer such as, for example, an acrylic/styrene copolymer.

In some instances, a sixteenth aspect of the disclosure can be described as a liquid detergent composition according to any one of the first through fifteenth aspects, wherein the liquid detergent further includes a chelating agent. In some instances, the chelating agent can be present in an amount ranging from about 1 to about 5 wt % of the detergent composition. In instances, the chelating agent is N,N-bis (carboxymethyl)-L-glutamic acid tetrasodium salt.

In some instances, a seventeenth aspect of the disclosure can be described as a liquid detergent composition according to any one of the first through sixteenth aspects, wherein the liquid detergent further includes one more preservatives. In some instances, the one more preservatives can be present in an amount ranging from about 0.05 to about 2 wt % of the detergent composition. In instances, the one more preservatives is a microbiocide, algicide, and/or fungicide.

In some instances, an eighteenth aspect of the disclosure can be described as a liquid detergent composition according to any one of the first through seventeenth aspects, wherein the liquid detergent further includes an aqueous enzyme comprising a protease, an amylase, and a mannanase. In some instances, the aqueous enzyme can be present in an amount ranging from about 1 to about 3 wt % of the detergent composition.

In some instances, a nineteenth aspect of the disclosure can be described as a method of cleaning laundry comprising diluting a detergent composition according to any one of the first through eighteenth aspects, and cleaning the laundry using the diluted detergent composition.

In some instances, a twentieth aspect of the disclosure can be described as a method of cleaning laundry comprising combining an amount of the detergent composition according to any one of the first through eighteenth aspects with an amount of water to form a diluted detergent composition having from about 0.1 grams to about 1 gram of the detergent composition per liter of water, and cleaning the laundry using the diluted detergent composition.

In some instances, a twenty-first aspect of the disclosure can be described as a liquid detergent composition comprising, consisting essentially of, or consisting of a sugar amine and a mixture of a nonionic surfactant and an anionic surfactant, wherein the detergent composition has a pH ranging from about 9 to about 12 and a zein score of less than about 2%.

In some instances, a twenty-second aspect of the disclosure can be described as a liquid detergent composition according to the twenty-first aspect, where the sugar amine in an amount ranging from about 0.01 to about 0.5 wt % of the detergent composition.

In some instances, a twenty-third aspect of the disclosure can be described as a liquid detergent composition according to the twenty-first or twenty-second aspect, where the mixture of the nonionic surfactant and the anionic surfactant is present in an amount ranging from about 3 to about 25 wt % of the detergent composition, and the mixture has a nonionic surfactant to anionic surfactant ratio ranging from about 5:1 to about 1:5.

In some instances, a twenty-fourth aspect of the disclosure can be described as a liquid detergent composition according to any one of the twenty-first through twenty-third aspects, wherein the detergent composition further includes one or more of a defoamer, sodium bicarbonate, an optical brightener, an anti-redeposition polymer, and a preservative.

In some instances, a twenty-fifth aspect of the disclosure can be described as a liquid detergent composition according to the twenty-fourth aspect, wherein the combined amount of the one or more of the defoamer, the sodium bicarbonate, the optical brightener, the anti-redeposition polymer, and the preservative ranges from about 5 to about 15 wt % of the detergent composition.

In some instances, a twenty-sixth aspect of the disclosure can be described as a liquid detergent composition according to any one of the twenty-first through twenty-fifth aspects, wherein the sugar amine is glucosamine HCl, glucose diamine, sorbitol amine, or any combination thereof.

In some instances, a twenty-seventh aspect of the disclosure can be described as a liquid detergent composition according to any one of the twenty-first through twenty-sixth aspects, wherein the sugar amine is in an amount ranging from about 0.1 to about 0.2 wt % of the detergent composition.

In some instances, a twenty-eighth aspect of the disclosure can be described as a liquid detergent composition according to any one of the twenty-first through twenty-seventh aspects, wherein the liquid detergent composition further include a chelating agent. In some instances, the chelating agent can be present in an amount ranging from about 0.1 to about 3 wt % of the detergent composition.

In some instances, a twenty-ninth aspect of the disclosure can be described as a method of cleaning laundry comprising diluting a detergent composition according to any one of the twenty-first through twenty-eighth aspects, and cleaning the laundry using the diluted detergent composition.

In some instances, a thirtieth aspect of the disclosure can be described as a method of cleaning laundry comprising combining an amount of the detergent composition according to any one of the twenty-first through twenty-eighth aspects with an amount of water to form a diluted detergent composition having from about 0.1 grams to about 1 gram of the detergent composition per liter of water, and cleaning the laundry using the diluted detergent composition.

### BRIEF DESCRIPTION OF THE DRAWINGS

In order that the present disclosure may be readily understood, aspects of the invention are illustrated by the way of examples in the accompanying drawings, in which like parts are referred to with like reference numeral throughout.

FIG. 1 is a graphical display showing the buffer capabilities of sugar amines compared to lysine and triethanolamine. The pH is measured as a function of NaOH addition to the solution.

### DETAILED DESCRIPTION

The following description of the embodiments is merely exemplary in nature and is in no way intended to limit the subject matter of the present disclosure, their application, or uses.

As used throughout, ranges are used as shorthand for describing each and every value that is within the range. Any value within the range can be selected as the terminus of the range. Unless otherwise specified, all percentages and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively ±5 percent, alternatively ±1 percent, alternatively ±0.5 percent, and alternatively ±0.1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

Various aspects of the present disclosure are directed to detergent compositions and methods of using the same. In accordance with various aspect of the disclosure, certain detergent compositions comprise, consist essentially of, or consist of a sugar amine, a fatty alcohol ethoxylate, an anionic surfactant, and water. In accordance with various aspect of the disclosure, other certain detergent compositions comprise, consist essentially of, or consist of a sugar amine, a mixture of a nonionic surfactant and an anionic surfactant, and water. In accordance with various aspects of the disclosure, the inventors have discovered the use of sugar amines in laundry detergent compositions serves at least two important purposes. First, sugar amines have shown to serve as effective pH buffer, whether used alone or in combination with other known pH buffers such as, for example, triethanolamine. Second, the inventors have discovered that sugar amines serve as effective chlorine scavengers when used in laundry detergent compositions. This is of importance since wash water (especially water from municipal sources) contains chlorine as a sanitization agent against microbes. Chlorine deteriorates dyes in fabrics over time, which may be observed (by, for example, reduced color saturation or intensity exhibited by the fabric) in 30 washes or less if not controlled. In addition to fabric dye damage, chlorine can negatively impact the cleaning performance of enzymes that may be present in laundry detergent compositions. As such, the use of sugar amines as a chlorine scavenger can help enhance enzyme cleaning performance and thus the overall cleaning efficiency of the laundry detergent composition.

Further, a suitable pH buffer is of importance to provide manufacturing facilities more flexibility for production, so it is much easier to hit the target pH, even if materials are added within a standard deviation of a target amount (for example ±2%). The inventors found the use of sugar amines can be effective in buffering liquid detergent compositions at various pH values including those in the 7 to 8 range, which is ideal for enzyme containing formulations. Within its buffer range, sugar amines can provide dual benefits (buffering and chlorine scavenging), whereas outside of the buffer range, it provides a chlorine scavenging benefit.

As used herein, the term “sugar amine” is directed to a broad class of compounds. In some instances, sugar amines suitable for use in liquid detergent compositions according to the disclosure are monosaccharides, in cyclic or open chain form, where at least three, alternatively at least two, alternatively at least one, alternatively three, alternatively two, alternatively one, and preferably one, hydroxyl group has been substituted with a secondary or primary amine, preferably a primary amine. Example monosaccharides include, but are limited to glucose, fructose, galactose, mannofuranose (i.e., mannose in five-membered ring form) and mannopyranose. By extension example sugar amines having a monosaccharide base structure may include, for example, glucosamine, galactosamine, N-acetylglucosamine, duanosamine, frustosamine, mannosamines, glucose diamines (for example, 2,6-diamino-2,3,6-trideoxy-alpha-D-glucose), and so on.

In some instances, sugar amines suitable for use in liquid detergent compositions according to the disclosure are disaccharides where at least three, alternatively at least two, alternatively at least one, alternatively three, alternatively two, alternatively one, and preferably one, hydroxyl group on one or both saccharide units has been substituted with a secondary or primary amine, preferably a primary amine. Example disaccharides include, but are limited to sucrose, lactose, maltose, trehaloses, cellobiose, chitobiose, kojibiose, nigerose, isomaltose, sophorose, laminaribiose, gentiobiose, trehalulose, turanose, maltulose, leucrose, isomaltulose, gentiobiulose, mannobiose, melibiose, allolactose, melibiulose, lactulose, rutinose, rutinulose and xylobiose. By extension example sugar amines having a disaccharide base structure may include, for example, lactosamine, N-acetyllactosamine, trehalosamines (for example, 2-trehalosamine, 3-trehalosamine and 4-trehalosamine), a glucosamine disaccharide form of chitobiose, an N,N′-diacetylglucosamine dimer form of chitobiose, and so on.

In some instances, sugar amines suitable for use in liquid detergent compositions according to the disclosure are sugar alcohols where at least three, alternatively at least two, alternatively at least one, alternatively three, alternatively two, alternatively one, and preferably one, hydroxyl group on one or both saccharide units has been substituted with a secondary or primary amine, preferably a primary amine. Example sugar alcohols include, but are not limited to sorbitol, xylitol, mannitol, erythritol, threitol, arabitol, ribitol, galactitol, fucitol, iditol, inositol, volemitol, maltitol, and lactitol. By extension example sugar alcohol amines may include, for example, sorbitol amine, mannitol amine, and so on.

In instances where a detergent composition according to various aspects of the disclosure comprises, consists essentially of, or consists of a sugar amine, a fatty alcohol ethoxylate, an anionic surfactant, and water, the sugar amine can be in an amount ranging from about 0.01 to about 2 wt % of the detergent composition. In some instances, the sugar amine is in an amount ranging from about 0.01 to about 10 wt %, alternatively from about 0.01 to about 8 wt %, alternatively from about 0.01 to about 6 wt %, alternatively from about 0.01 to about 5 wt %, alternatively from about 0.01 to about 4 wt %, and alternatively from about 0.01 to about 10 wt % of the detergent composition. In some instances, the sugar amine is in an amount ranging from about 0.05 to about 1.75 wt %, alternatively from about 0.1 to about 1.5 wt %, alternatively from about 0.15 to about 1.25 wt %, alternatively from about 0.2 to about 1.0 wt %, alternatively from about 0.25 to about 1.0 wt %, and alternatively from about 0.25 to about 0.75 wt % of the detergent composition. In some instances, the sugar amine can be about 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, and 2.0 wt % of the detergent composition. The sugar amine can be any compound as described above, a salt thereof, or any combination one or more sugar amines and/or sugar amine salts. In some instances, the use of glucosamine, sorbitol amine, glucose diamines, salts thereof, or any combination of any of the foregoing as the sugar amine may be preferred. In some instances, the use of glucosamine HCl as the sugar amine may be preferred.

In instances where a detergent composition according to various aspects of the disclosure comprises, consists essentially of, or consists of a sugar amine, a fatty alcohol ethoxylate, an anionic surfactant, and water, the fatty alcohol ethoxylate can be in an amount ranging from about 5 to about 30 wt % of the detergent composition. In some instances, the fatty alcohol ethoxylate is in an amount ranging from about 1 to about 50 wt %, alternatively from about 2.5 to about 45 wt %, alternatively from about 2.5 to about 40 wt %, alternatively from about 5 to about 35 wt % of the detergent of composition. In some instances, the fatty alcohol ethoxylate is in an amount ranging from about 7.5 to about 27.5 wt %, alternatively from about 10.0 to about 25.0 wt %, alternatively from about 12.5 to about 22.5 wt %, alternatively from about 15.0 to about 20.0 wt %, and alternatively from about 17.0 to about 19.0 wt % of the detergent of composition. Suitable fatty acid ethoxylates include, but are not limited to, those having alkyl chains of from C₈-C₃₅, alternatively C₈-C₂₄, alternatively C₈-C₁₈, and alternatively C₁₀-C₁₈ carbon atoms, and 3 to 9 ethylene oxide units. In some instances, lauric acid ethoxylates such as, for example, laureth-4 ethylene oxide, laureth-5 ethylene oxide, and laureth-6 ethylene oxide may be preferred. In some instances, laureth-6 ethylene oxide may be most preferred.

In instances where a detergent composition according to various aspects of the disclosure comprises, consists essentially of, or consists of a sugar amine, a fatty alcohol ethoxylate, an anionic surfactant, and water, the anionic surfactant can be in an amount ranging from about 5 to about 35 wt % of the detergent composition. In some instances, the anionic surfactant is in an amount from about 5, 7.5, 10, 12.5, 15, 17.5, 20, 22.5, 25, 27.5, 30, 32.5, or 35 wt % of a detergent composition. Various classes of anionic surfactants may be used. In some instances, the anionic surfactant is a linear alkyl sulfonate (LAS) or a linear alkylbenzene sulfonate (LABS). LAS and LABS are water soluble salts between 8 and 22 carbon atoms in the alkyl group. In some instances, suitable LAS and/or LABS compounds may include salts of C₈-C₁₈ alkyl sulfonic acids and salts of C₈-C₁₈ alkylbenzyl sulfonic acids. Suitable in some instances, the anionic surfactant is a linear alkyl ether (or laureth) sulfonate. In some instances, suitable linear alkyl ether sulfonates include a linear C₈-C₁₈ alkyl chain, 4-9 repeating ethylene oxide units, and an anionic head group made up of the sulfonate group and a counter cation. Suitable counter cations for LAS, LABS and linear alkyl ether sulfonates include, but are not necessarily limited to, Na⁺, K⁺, and NH₄⁺. In some instances, the anionic surfactant is sodium or potassium lauryl sulfate or a sodium or potassium lauryl ether sulfate.

Detergent compositions according to various aspects of the disclosure comprising, consisting essentially of, or consisting of a sugar amine, a fatty alcohol ethoxylate, an anionic surfactant, and water can have pH values ranging from about 5 to 12, alternatively from about 5.5 to about 12, alternatively, alternatively from about 6 to about 12, alternatively from about 6.5 to about 12, alternatively from about 9 to about 12, alternatively from about 7 to about 12, and alternatively from about 7 to about 11.5. For example, when such detergent compositions include one or more enzymes, as discussed further below, the pH value may optimally range from about 7 to about 9 to promote stability of said one or more enzymes. Also, for example, detergent compositions do not contain enzymes can have a pH as high as about 10, alternatively as high as about 10.5, alternatively as high as about 11, and alternatively as high as about 11.5.

In some instances, detergent compositions according to various aspects of the disclosure comprise, consist essentially of, or consist of a sugar amine, a mixture of a nonionic surfactant and an anionic surfactant, and water. In some instances, such detergent compositions may exhibit a pH ranging from about 9 to about 12, a zein score of less than about 2%, or both. In some instances, the pH of such detergent compositions can range from about 7 to about 12. In some instances, the pH of such detergent compositions can range from about 8 to about 12. In some instances, the pH of such detergent compositions can range from about 10 to about 12.

In instances where a detergent composition according to various aspects of the disclosure comprises, consists essentially of, or consists of a sugar amine, a mixture of a nonionic surfactant and an anionic surfactant, and water, the types of sugar amines that can be use are as described previously herein. In some instances, the sugar amine can be in an amount ranging from about 0.01 to about 0.5 wt % of the detergent composition. In some instances, the sugar amine is in an amount ranging from about 0.001 to about 5 wt %, alternatively from about 0.002 to about 4.5 wt %, alternatively from about 0.003 to about 4 wt %, alternatively from about 0.004 to about 3.5 wt %, alternatively from about 0.005 to about 3 wt %, alternatively from about 0.006 to about 2.5 wt %, alternatively from about 0.007 to about 2 wt %, alternatively from about 0.008 to about 1.5 wt %, and alternatively from about 0.009 to about 1 wt % of the detergent composition.

In instances where a detergent composition according to various aspects of the disclosure comprises, consists essentially of, or consists of a sugar amine, a mixture of a nonionic surfactant and an anionic surfactant, and water, the type of anionic surfactants that can be used are as described previously herein. In some instances, the nonionic surfactant is but not limited to alkoxylated alcohols, polyoxyalkylene alkyl ethers, polyoxyalkylene alkylphenyl ethers, polyoxyalkylene sorbitan fatty acid esters, polyoxyalkylene sorbitol fatty acid esters, polyalkylene glycol fatty acid esters, alkyl polyalkylene glycol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, alkylamine oxides, or any combinations thereof. In some instances, the mixture of the nonionic surfactant and anionic surfactant is in an amount ranging from about 3 to about 25 wt % of the detergent composition. In some instances, the mixture of the nonionic surfactant and anionic surfactant is in an amount ranging from about 5 to about 22.5 wt %, alternatively from about 10 to about 20 wt %, alternatively from about 15 to about 20 wt %, and alternatively from about 16 to about 18 wt % of the detergent composition. In some instances, the mixture of the nonionic surfactant and anionic surfactant is in an amount ranging from about 1 to about 50 wt %, alternatively from about 1.5 to about 45 wt %, alternatively from about 2 to about 40 wt %, alternatively from about 2.5 to about 35 wt %, and alternatively from about 3 to about 35 wt % of the detergent composition. In some instances, the ratio of nonionic surfactants to anionic surfactant ranges from about 5:1 to about 1:5. In some instances, the ratio of nonionic surfactants to anionic surfactant can range from about 4:1 to about 1:4, alternatively from about 3:1 to about 1:3, alternatively from about 2:1 to about 1:2, alternatively from about 1.5:1 to about 1:1.5, and alternatively about 1:1. In some instances, the ratio of nonionic surfactants to anionic surfactant can range from about 10:1 to about 1:10, alternatively from about 9:1 to about 1:9, alternatively from about 8:1 to about 1:8, alternatively from about 7:1 to about 1:7, and alternatively from about 6:1 to about 1:6.

In some instances, detergent compositions according to various aspects of the disclosure may further comprise a suitable tetraborate salt such as, for example, sodium tetraborate. In some instances, a suitable tetraborate salt can be present in an amount ranging from about 0.1 to about 1.0 wt % of a detergent composition. In some instances, a suitable tetraborate salt can be present in an amount ranging from about 0.01 to about 2.0 wt %, alternatively from about 0.025 to about 1.75 wt %, alternatively from about 0.05 to about 1.5 wt %, and alternatively from about 0.075 to about 1.25 wt % of a detergent composition. In some instances, the tetraborate salt is in an amount of about 0.1, 0.2, 0.3, 0.4, 0.5, 0.6, 0.7, 0.8, 0.9, or 1.0 wt % of a detergent composition.

In some instances, detergent compositions according to various aspects of the disclosure may further comprise a strong base. In some instances, the strong base is in an amount ranging from about 0.5 to about 5 wt % of the detergent composition. In some instances, the amount of the strong base is about 2.4 wt % of the detergent composition. In some instances, the strong base can be, for example, potassium hydroxide, sodium hydroxide, or calcium hydroxide. Generally, any amount of strong base may be added to a detergent composition to provide said detergent composition with a target end property such as, for example, pH.

In some instances, detergent compositions according to various aspects of the disclosure may further comprise a weak acid. In some instances, the weak acid is in an amount ranging from about 0.5 to about 6.0 wt % of the detergent composition. In some instances, the weak acid can be, for example, citric acid, acetic acid, lactic acid, stearic acid, palmitic acid, or oleic acid. Generally any amount of weak acid may be added to a detergent composition to provide said detergent composition with a target end property such as, for example, pH.

In some instances, detergent compositions according to various aspects of the disclosure may include both a strong acid and a weak acid as described above.

In some instances, detergent compositions according to various aspects of the disclosure may include a fatty acid. In some instances the fatty acid is in an amount ranging from about 0.1 to about 1 wt % of the detergent composition. In some instances, the fatty acid is a coconut fatty acid. In some instances, the fatty acid may be one or more of lauric, myristic, palmitic, stearic, ricinoleic, oleic, linoleic, or linolenic acids.

In some instances, detergent compositions according to various aspects of the disclosure may include an aqueous enzyme solution comprising a cocktail of one or more enzymes. In some instances, the one or more enzymes may include, for example, one or more of an amylase, a protease, and a mannanase. In some instances, the aqueous enzyme solution is in an amount ranging from about 1 to about 3 wt % of the detergent composition.

In some instances, detergent compositions according to various aspects of the disclosure may include a chelating agent. In some instances, the chelating agent is in an amount ranging from about 1 to about 5 wt % of the detergent composition. In some instances, the chelating agent is N,N-bis (carboxymethyl)-L-glutamic acid tetrasodium salt. Chelating agents are sometimes used as water softeners in detergent compositions. In some instances, the chelating agent is iminodisuccinate (IDS), ethylenediaminetetraacetic acid (EDTA), nitrilotriacetic acid, diethylenetriaminepenta (methylenephosphonic acid), nitrilotris (methylenephosphonic acid), 1-hydroxyethane-1,1-diphosphonic acid, ethylenediamine-N,N′-disuccinic acid (EDDS), hydroxyethylenediaminetriacetic acid (HEDTA), N,N-bis (carboxymethyl)-L-glutamic acid tetrasodium salt, Alanine, N,N-bis (carboxymethyl)-alanine, trisodium salt or other chelating compounds.

In some instances, detergent compositions according to various aspects of the disclosure may include a preservative. In some instances, the preservative is in an amount ranging from about 0.05 to about 2 wt % of the detergent composition. In some instances, the preservative is one or more of a microbiocide, an algicide, and a fungicide. In some instances, the preservative is a mixture of 5-chloro-2-methyl-2H-isothiazol-3-one and 2-methylisothiazol-3 (2H)-one and 1,2-benzisothiazol-3(2H)-one. In some instances, preservative is methylisothiazolinone, chloromethylisothiazolinone, benzisothiazolinone, sorbic acid, sodium benzoate, formaldehyde, borate, and glutaraldehyde. In some instances, detergent compositions according to various aspects of the disclosure may be free of, or substantially free of, preservatives.

In some instances, detergent compositions according to various aspects of the disclosure may include an anti-redeposition polymer. In some instances, anti-redeposition agents include polymers with a soil detachment capacity, which are also known as “soil repellents” due to their ability to provide a soil-repelling finish on the treated surface, such as a fibers. In some instances, the anti-redeposition polymer is in an amount ranging from about 0.1 to about 1 wt % of the detergent composition. In some instances, the anti-redeposition polymer is an acrylic/styrene copolymer. In some instances, the polymer can be a polyester. In some instances, the polyesters include co-polyesters prepared from dicarboxylic acids, such as adipic acid, phthalic acid or terephthalic acid. In some instances, an anti-redeposition agents includes polyesters with a soil detachment capacity that include those compounds which, in formal terms, are obtainable by esterifying two monomer moieties, the first monomer being a dicarboxylic acid HOOC-Ph-COOH and the second monomer a diol HO—(CHR—)ₐOH, which may also be present as a polymeric diol H—(O—(CHR—)ₐ)_{b}OH. “Ph” here means an ortho-, meta-or para-phenylene residue that may bear 1 to 4 substituents selected from alkyl residues with 1 to 22 C atoms, sulfonic acid groups, carboxyl groups and mixtures thereof, “R” means hydrogen or an alkyl residue with 1 to 22 C atoms and mixtures thereof, “a” means a number from 2 to 6 and “b” means a number from 1 to 300. In some instances, the polyesters obtainable therefrom may contain not only monomer diol units —O—(CHR—)ₐO— but also polymer dial units —(O—(CHR—)ₐ)_{b}O—. In some instances, the molar ratio of monomer diol units to polymer diol units may amount to from about 100:1 to about 1:100, or alternatively from about 10:1 to about 1:10. In some instances, the polymer diol units, the degree of polymerization “b” may be in the range of from about 4 to about 200, or alternatively from about 12 to about 140. In some instances, the number average molecular weight of the polyesters with a soil detachment capacity may be in the range of from about 250 to about 100,000, or alternatively from about 500 to about 50,000. In some instances, the acid on which the residue Ph is based may be selected from terephthalic acid, isophthalic acid, phthalic acid, trimellitic acid, mellitic acid, the isomers of sulfophthalic acid, sulfoisophthalic acid and sulfoterephthalic acid and mixtures thereof. In some instances, the acid groups thereof are not part of the ester bond in the polymer, they may be present in salt form, such as an alkali metal or ammonium salt.

In some instances, instead of the monomer HOOC-Ph-COOH, polyesters with a soil detachment capacity (the anti-redeposition agent) may include small proportions, for example up to about 10 mole percent relative to the proportion of Ph with the above-stated meaning, of other acids that include at least two carboxyl groups. These include, for example, alkylene and alkenylene dicarboxylic acids such as malonic acid, succinic acid, fumaric acid, maleic acid, glutaric acid, adipic acid, pimelic acid, suberic acid, azelaic acid and sebacic acid. Exemplary diols HO—(CHR—)ₐOH include those in which R is hydrogen and “a” is a number of from about 2 to about 6, and in some instances those in which “a” has the value of 2 and R is selected from hydrogen and alkyl residues with 1 to 10 C atoms, or where R is selected from hydrogen and alkyl residues with 1 to 3 C atoms in another embodiment. Examples of diol components include ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol and neopentyl glycol. The polymeric diols may include polyethylene glycol with an average molar mass in the range from about 1000 to about 6000. In some instances, these polyesters may also be end group-terminated, with end groups that may be alkyl groups with 1 to 22 C atoms or esters of monocarboxylic acids. The end groups attached via ester bonds may be based on alkyl, alkenyl and aryl monocarboxylic acids with 5 to 32 C atoms, or alternatively with 5 to 18 C atoms. These may include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselinic acid, petroselaidic acid, oleic acid, linoleic acid, linolaidic acid, linolenic acid, eleostearic acid, arachidic acid, gadoleic acid, arachidonic acid, behenic acid, erucic acid, brassidic acid, clupanodonic acid, lignoceric acid, cerotic acid, melissic acid, benzoic acid, which may bear 1 to 5 substituents having a total of up to 25 C atoms, or alternatively 1 to 12 C atoms, for example tert-butylbenzoic acid. The end groups may also be based on hydroxymonocarboxylic acids with 5 to 22 C atoms, which for example include hydroxyvaleric acid, hydroxycaproic acid, ricinoleic acid, the hydrogenation product thereof, hydroxystearic acid, and ortho-, meta-and para-hydroxybenzoic acid. The hydroxymonocarboxylic acids may in turn be joined to one another via their hydroxyl group and their carboxyl group and thus be repeatedly present in an end group. The number of hydroxymonocarboxylic acid units per end group, i.e. their degree of oligomerization, may be in the range of from 1 to 50, or alternatively in the range of from 1 to 10. In some instances, polymers of ethylene terephthalate and polyethylene oxide terephthalate, in which the polyethylene glycol units have molar weights of from about 750 to about 5000 and the molar ratio of ethylene terephthalate to polyethylene oxide terephthalate of from about 50:50 to about 90:10, can be used alone or in combination with cellulose derivatives.

In some instances, detergent compositions according to various aspects of the disclosure may include an optical brightener. Optical brighteners adsorb ultraviolet and/or violet light and re-transmit it as visible light, typically a visible blue light. Optical brighteners include, but are not limited to, derivatives of diaminostilbene disulfonic acid or alkali metal salts thereof. Suitable compounds are, for example, salts of 4,4′-bis (2-anilino-4-morpholino-1,3,5-triazinyl-6-amino) stilbene 2,2′-disulfonic acid or compounds of similar structure which, instead of the morpholino group, bear a diethanolamino group, a methylamino group, an anilino group or a 2-methoxyethylamino group. Optical brighteners of the substituted diphenylstyryl type may furthermore be present, such as the alkali metal salts of 4,4′-bis (2-sulfostyryl) diphenyl, 4,4′-bis(4-chloro-3-sulfostyryl) diphenyl, or 4-(4-chlorostyryl)-4′-(2-sulfostyryl) diphenyl. Mixtures of the above-stated optical brighteners may also be used. In some instances, optical brighteners may be present in detergent compositions in an amount ranging about 0.01 to about 0.5 wt %, alternatively from about 0.01 to about 1 wt %, alternatively from about 0.01 to about 3 wt %, or alternatively from 0.01 to about 5 wt % of the detergent composition.

In some instances, detergent compositions according to various aspects of the disclosure may include one or more foam inhibitors (i.e, defoamers). In some instances, foam inhibitors include, but are not limited to, fatty acids such as coconut fatty acids. In some instances, suitable foam inhibitors include, for example, soaps of natural or synthetic origin (which may exhibit elevated proportions of C₁₈-C₂₄ fatty acids), organopolysiloxanes and mixtures thereof with microfine (and optionally silanized) silica, paraffins, waxes, microcrystalline waxes and mixtures thereof with silanized silica or bis-fatty acid alkylenediamides (for example, bistearylethylenediamide), silicones, and combinations thereof. In some instances, foam inhibitors may be present in detergent compositions in an amount ranging about 0.01 to about 0.5 wt %, alternatively from about 0.01 to about 0.1 wt %, alternatively from about 0.01 to about 3 wt %, or alternatively from 0.01 to about 5 wt % of the detergent composition.

In some instances, detergent compositions according to various aspects of the disclosure may include bittering agents to hinder accidental ingestion of the composition. Bittering agents are compositions that taste bad, so children or others are discouraged from accidental ingestion. In some instances, the bittering agent is denatonium benzoate, aloin, or others. Bittering agents may be present in the composition in an amount ranging about 0.01 to about 0.5 wt %, alternatively from about 0.01 to about 0.1 wt %, alternatively from about 0.01 to about 3 wt %, or alternatively from 0.01 to about 5 wt % of the detergent composition.

In some instances, detergent compositions according to various aspects of the disclosure may include sodium sulfite. Sodium sulfite is an oxygen scavenger, where sodium sulfite reacts with oxygen to form sodium sulfate. Free oxygen, such as oxygen dissolved in the wash composition, can react to produce metal oxides (rust) that reduce the life of the washing equipment. The metal oxides can also stain garments, dishes, or other items being washed. Dissolved oxygen can also react to produce other components, and some of those components may be colored bodies. Therefore, the sodium sulfite can help reduce the formation of colored bodies in the wash composition. However, sodium sulfite includes sodium, and sodium-containing compounds tend to produce efflorescent solids in the film. In some instances, the sodium sulfite is present in the wash composition at a concentration of from about 0.05 to about 4 weight percent, or from about 0.05 to about 3 weight percent, or from about 0.05 to about 2 weight percent, all based on the total weight of the wash composition.

In some instances, detergent compositions according to various aspects of the disclosure may include a combination of two or more of, or all of, a defoamer, sodium bicarbonate, an optical brightener, an anti-redeposition polymer, and a preservative. In some instances, the combined amount of two or more of, or all of, the defoamer, the sodium bicarbonate, the optical brightener, the anti-redeposition polymer, and the preservative ranges from about 5 to about 15 wt % of the detergent composition.

Also provided herein are methods of cleaning laundry. Methods of cleaning laundry may include combining an amount of a detergent composition according to various aspects of the disclosure with an amount of water to form a diluted detergent composition having from about 0.1 grams to about 1 gram of the detergent composition per liter of water and cleaning the laundry using the diluted detergent composition. In some instances the diluted detergent composition has a concentration of about 0.01 to about 10 grams, alternatively from about 0.02 to about 8 grams, alternatively from about 0.03 to about 6 grams, alternatively from about 0.04 to about 6 grams, alternatively from about 0.05 to about 5 grams, alternatively from about 0.06 to about 4 grams, alternatively from about 0.07 to about 3 grams, alternatively from about 0.08 to about 2 grams, and alternatively from about 0.09 to about 1.5 grams of the detergent composition per liter of water.

As used herein the phrase “Zein score” refers the measurement obtained from the Zein test as described herein. It can also be referred to as “Zein solubilized %.” In some instances, detergent compositions described herein have a Zein score of less than about 3% when tested as a 10% dilution. In certain instances, detergent compositions described herein have a Zein score of from about 0.01% to about 3%, alternatively from about 0.01% to about 2.75%, alternatively from about 0.01% to about 2.5%, alternatively from about 0.01% to about 2.25%, alternatively from about 0.01% to about 2%, alternatively from about 0.01% to about 1.75%, alternatively from about 0.01% to about 1.5%, alternatively from about 0.01% to about 1.25%, and alternatively from about 0.01% to about 1% when tested as a 10% dilution. In other instances, detergent compositions described herein can have a Zein score of less than about 2.75%, preferably less than about 2.5%, more preferably less than about 2.25%, even more preferably less than about 2%, even more preferably less than 1.75%, even more preferably less than about 1.5%, even more preferably less than about 1.25%, and even more preferably less than about 1% when tested as a 10% dilution.

In some instances, detergent compositions described herein have a Zein score less than 0.5%. In some instances, detergent compositions described herein have a Zein score ranging from about 0.3 to about 0.4%. The Zein score is used in these instances as a measurement of how mild the laundry detergent is as explained in the examples.

One method to test the skin irritancy potential of a surfactant composition is Zein test. Zein score is measured using a Zein test (Gott, E., Aesthet. Medzin., Tenside 15: 313(1966)). Zein test determines the extent of denaturation of Zein corn protein after exposure to a surfactant for a given period of time. Generally, the higher the Zein score, the greater the skin irritation potential.

Another method to measure the skin irritancy potential is corneosurfametry (CSM) test, a noninvasive quantitative test that measures the interaction between surfactants and human stratum corneum (Pierard et al., Dermatology 189:152-156(1994)). Corneosurfametry involves removing a few layers of skin using cyanoacrylate skin surface strippings, short contact time with surfactants followed by staining the samples with fuchian dyes. A less damaged barrier allows greater penetration of the stain, therefore giving a more intense color, which is measured using colorimetrically with L*a*b* color space. This method is predictive of both protein and lipid damage in the skin. CIM (Color Indicator of Mildness) values are obtained from a corneosurfametry test. In a comparative study, the higher the CIM value, the milder the surfactant formulation.

A third method to evaluate the irritation effect of a surfactant formulation is measured by cytokine release of representative human skin model in response to the surfactant formulation. Where skin tissue viability is not decreased by 50% as compared to the negative control tissue (as measured by MTT reduction), the inflammatory potential is then measured by the production of the cytokines IL-la. and/or IL-1ra. MTT is a dye used to stain the skin cells called 3-(4, 5-dimethylthiazol-2-yl)-2,5-diphenyltetrazolium bromide. In a comparative study, a lower cytokine release value means a milder surfactant formulation.

Describe in US 2018/0016523, the entire contents of which are incorporated by reference herein, are methods for determining how mild an aqueous laundry detergent formulation is for a user. The method comprises the steps of: (i) providing a solution comprising a laundry cleaning effective amount of a surfactant composition, (ii) subjecting an appropriate dilution of the solution to Zein test, corneosurfametry test, and in vitro cytokine release test for IL-la and IL-1ra response, respectively, to obtain a Zein score, a corneosurfametric (CSM) value, and a cytokine release value, and (iii) deriving at composite mildness indicator (CMI) for each solution based the Zein score, the CSM value, and the cytokine release value.

The composite mildness indicator (CMI) may also be called detergent mildness indicator (DMI). Specifically, the CMI can be derived from (1) the Zein score, CSM value, and cytokine release value IL-la of the formulation; (2) the Zein score, CSM value, and cytokine release value (IL-la+IL−1ra) of the formulation; (3) the Zein score, CSM value, and cytokine release value (IL-1ra/IL-la) of the formulation; (4) the Zein score, CSM value, and cytokine release value log10 (IL-1ra/IL-la) of the formulation; or (5) the Zein score, CSM value, and cytokine release measurement (IL-1α/IL-1ra) of the formulation.

### EXAMPLES

### Example 1

### Sugar Amines Ravage Chlorine in Laundry Detergents

Formulations, i.e., Formulas 1 (control) and 2 (inventive), were prepared with the components listed in Table 1.

TABLE 1

| | Raw | Wt % of | Wt % of |
|---|---|---|---|
| | Material | Formula 1 | Formula 2 |
| Component | Activity | (Control) | (Inventive) |
| Water, demineralized | 100 | q/s too 100 | q/a to 100 |
| | | (about 39.33) | (about 39.33) |
| Citric Acid | 50 | 4.5 | 4.5 |
| Sodium Tetraborate 5H₂0 | 100 | 0.5 | 0.5 |
| 50% NaOH | 50 | 2.4 | 2.4 |
| Fatty alcohol ethoxylate | 100 | 18 | 18 |
| (Laureth-6 EO) | | | |
| Sodium Lauryl Sulfate | 29 | 30 | 30 |
| Coconut Fatty Acid, Anti- | N/A | 5.28 | 5.28 |
| redeposition Polymer, | | | |
| Chelating agent, | | | |
| Preservative, Aqueous | | | |
| Enzyme Solution (protease, | | | |
| amylase, Mannanase blend) | | | |
| Glucosamine HCl | 99 | 0 | 0.5 |

The target dose of detergent per wash was 15.5 grams, and the estimated amount of water in a High Efficiency Washing Machine was 31.4 L. Proportionally, 0.5 grams of detergent was added into 1 L of water for benchtop scale.

With a starting chlorine concentration of 1 ppm of hypochlorite in the water, the results in Table 2 were observed after adding 0.5 grams of Formula 1, 2, or 3 to 1 L of the chlorinated water. The sugar amine was able to scavenge chlorine compared to the control.

TABLE 2

| | | | Chlorine Concentration after | | | |
|---|---|---|---|---|---|---|
| | | Initial Chlorine | Contact with Formula (ppm) | | | |
| | Solution | Concentration | 15 | 30 | 60 | 120 |
| Formula | Agitated | (ppm) | sec | sec | sec | sec |
| 1 (control) | Yes | 1 | 1 | 1 | 1 | 1 |
| 2 (inventive) | Yes | 1 | 0 | 0 | 0 | 0 |

### Example 2

### Sugar Amines Act as pH Buffer

Monoethanolamine has been observed to suitably buffer solutions from a pH 7 to 9. As observed in the example below, Glucosamine buffers from pH 6.8 to 8.6. The following example compares TEA, Glucosamine and Lysine (pH 9-10)'s buffering capabilities.

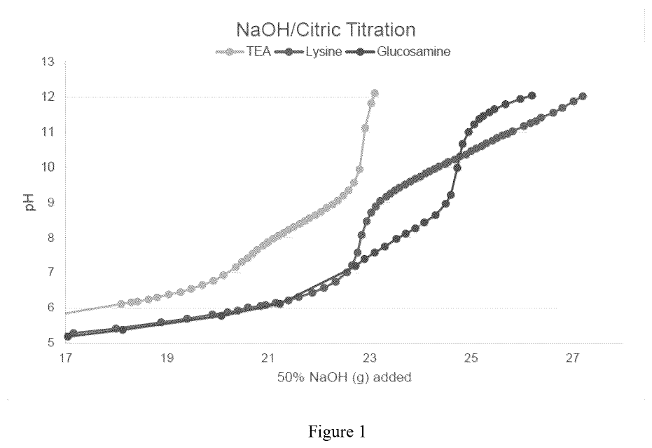

Three solutions of 350 grams of deionized water, 35 grams of 50% citric acid in water, and then 5 grams of active triethanolamine (TEA), lysine (from Lysine HCl (99% active), and Glucosamine (from Glucosamine HCl (99% Active) were prepared for a titration with 50% NaOH in water. This system simulates the main acidic and basic components of a liquid laundry detergent to measure what pH Glucosamine can buffer effectively compared to the historical use of triethanolamine. The following results were observed, as set forth in Table 3 and FIG. 1

TABLE 3

| TEA | | Lysine HCl | | Glucosamine HCl | |
|---|---|---|---|---|---|
| 50% NaOH | | 50% NaOH | | 50% NaOH | |
| Added (g) | pH | Added | pH | Added | pH |
| 2.87 | 3.35 | 1.36 | 2.58 | 2.28 | 2.5 |
| 5.16 | 3.78 | 2.5 | 2.76 | 5.6 | 3.19 |
| 7.55 | 4.21 | 3.9 | 3 | 7.23 | 3.51 |
| 10 | 4.59 | 5.24 | 3.25 | 9.62 | 3.95 |
| 12.55 | 5 | 6.5 | 3.47 | 12.5 | 4.42 |
| 15.39 | 5.44 | 7.6 | 3.67 | 15.44 | 4.90 |
| 18.1 | 6.1 | 9.1 | 3.94 | 17.05 | 5.17 |
| 18.3 | 6.15 | 10.17 | 4.12 | 18.13 | 5.36 |
| 18.42 | 6.17 | 11.75 | 4.38 | 20.08 | 5.76 |
| 18.64 | 6.23 | 12.6 | 4.51 | 21.23 | 6.10 |
| 18.81 | 6.29 | 14 | 4.73 | 22.72 | 7.18 |
| 19.04 | 6.37 | 15.4 | 4.97 | 22.9 | 7.38 |
| 19.27 | 6.44 | 16.16 | 5.1 | 23.1 | 7.56 |
| 19.48 | 6.53 | 17.16 | 5.27 | 23.3 | 7.73 |
| 19.7 | 6.64 | 18 | 5.4 | 23.53 | 7.95 |
| 19.92 | 6.76 | 18.89 | 5.58 | 23.71 | 8.10 |
| 20.12 | 6.92 | 19.4 | 5.68 | 23.9 | 8.25 |
| 20.36 | 7.15 | 19.9 | 5.8 | 24.08 | 8.42 |
| 20.48 | 7.3 | 20.2 | 5.86 | 24.3 | 8.63 |
| 20.59 | 7.4 | 20.4 | 5.91 | 24.5 | 8.95 |
| 20.69 | 7.53 | 20.6 | 6 | 24.6 | 9.20 |
| 20.78 | 7.64 | 20.85 | 6.04 | 24.73 | 9.97 |
| 20.9 | 7.76 | 20.95 | 6.07 | 24.83 | 10.65 |
| 20.99 | 7.85 | 21.15 | 6.13 | 24.95 | 10.99 |
| 21.1 | 7.96 | 21.4 | 6.2 | 25.06 | 11.21 |
| 21.2 | 8.04 | 21.6 | 6.3 | 25.16 | 11.36 |
| 21.3 | 8.12 | 21.87 | 6.42 | 25.24 | 11.45 |
| 21.4 | 8.21 | 22.1 | 6.56 | 25.36 | 11.55 |
| 21.5 | 8.29 | 22.33 | 6.73 | 25.46 | 11.64 |
| 21.62 | 8.38 | 22.55 | 7 | 25.68 | 11.78 |
| 21.72 | 8.46 | 22.65 | 7.2 | 25.97 | 11.93 |
| 21.81 | 8.54 | 22.76 | 7.56 | 26.2 | 12.03 |
| 21.93 | 8.63 | 22.84 | 8.06 | | |
| 22.04 | 8.72 | 22.94 | 8.45 | | |
| 22.15 | 8.83 | 23.03 | 8.7 | | |
| 22.27 | 8.93 | 23.12 | 8.87 | | |
| 22.37 | 9.04 | 23.21 | 9.03 | | |
| 22.48 | 9.18 | 23.33 | 9.15 | | |
| 22.58 | 9.33 | 23.41 | 9.24 | | |
| 22.69 | 9.55 | 23.5 | 9.33 | | |
| 22.8 | 9.93 | 23.59 | 9.41 | | |
| 22.91 | 11.11 | 23.7 | 9.5 | | |
| 23.03 | 11.81 | 23.8 | 9.58 | | |
| 23.1 | 12.1 | 23.9 | 9.66 | | |
| | | 24 | 9.72 | | |
| | | 24.1 | 9.81 | | |
| | | 24.18 | 9.87 | | |
| | | 24.28 | 9.94 | | |
| | | 24.37 | 10.01 | | |
| | | 24.49 | 10.08 | | |
| | | 24.55 | 10.14 | | |
| | | 24.68 | 10.21 | | |
| | | 24.78 | 10.3 | | |
| | | 24.9 | 10.35 | | |
| | | 25 | 10.45 | | |
| | | 25.1 | 10.52 | | |
| | | 25.21 | 10.59 | | |
| | | 25.3 | 10.67 | | |
| | | 25.42 | 10.74 | | |
| | | 25.51 | 10.82 | | |
| | | 25.62 | 10.89 | | |
| | | 25.72 | 10.94 | | |
| | | 25.82 | 11.01 | | |
| | | 26.04 | 11.16 | | |
| | | 26.17 | 11.24 | | |
| | | 26.28 | 11.3 | | |
| | | 26.38 | 11.4 | | |
| | | 26.62 | 11.54 | | |
| | | 26.8 | 11.68 | | |
| | | 27.02 | 11.86 | | |
| | | 27.2 | 12.01 | | |

### Example 3

### Formulation of Sugar Amine Detergents and a High pH Sugar Amine Detergent Composition

Exemplary enzymatic formulations containing sugar amines are described below in Tables 4, 5 and 6, below.

TABLE 4

| | RM | Formu- | Formu- | Formu- | Formu- |
|---|---|---|---|---|---|
| | Activity | la 5 | la 6 | la 7 | la 8 |
| DI Water | 100.00% | q/s | q/s | q/s | q/s |
| | | to 100 | to 100 | to 100 | to 100 |
| Laureth-6 plant | 100.00% | 18.00 | 18.00 | 18.00 | 18.00 |
| based EO | | | | | |
| Sodium Lauryl Sulfate | 29.00% | 30.00 | 30.00 | 30.00 | 30.00 |
| Glucosamine HCl | 99.00% | 0.25 | 0.5 | 0.75 | 1 |
| Anti-redeposition | 35.00% | 0.44 | 0.44 | 0.44 | 0.44 |
| Polymer | | | | | |
| EDDS Chelant (47% | N/A | 7.67 | 7.67 | 7.67 | 7.67 |
| active), Preservative | | | | | |
| (16% active), Anti- | | | | | |
| redeposition Polymer, | | | | | |
| Fatty Acid, Citric Acid | | | | | |
| (50%), and Sodium | | | | | |
| Hydroxide (50%, to | | | | | |
| adjust pH to 8) | | | | | |
| Protease, Amylase, | 100.00% | 2.1 | 2.1 | 2.1 | 2.1 |
| Mannanase | | | | | |

TABLE 5

| | RM | Formu- | Formu- | Formu- | Formu- |
|---|---|---|---|---|---|
| | Activity | la 6 | la 7 | la 8 | la 9 |
| DI Water | 100.00% | q/s | q/s | q/s | q/s |
| | | to 100 | to 100 | to 100 | to 100 |
| Laureth-6 plant | 100.00% | 18.00 | 18.00 | 18.00 | 18.00 |
| based EO | | | | | |
| Sodium Lauryl sulfate | 29.00% | 30.00 | 30.00 | 30.00 | 30.00 |
| Sorbitol Amine | 99.00% | 0.25 | 0.5 | 0.75 | 1 |
| Anti-redeposition | 35.00% | 0.44 | 0.44 | 0.44 | 0.44 |
| Polymer | | | | | |
| EDDS Chelant (47% | 47.00% | 7.67 | 7.67 | 7.67 | 7.67 |
| active), Preservative | | | | | |
| (16% active), Anti- | | | | | |
| redeposition Polymer, | | | | | |
| Fatty Acid, Citric | | | | | |
| Acid (50%), and | | | | | |
| Sodium Hydroxide | | | | | |
| (50%, to adjust pH to | | | | | |
| 8) | | | | | |
| Protease, Amylase, | 100.00% | 2.1 | 2.1 | 2.1 | 2.1 |
| Mannanse | | | | | |

TABLE 6

| | RM | | | | |
|---|---|---|---|---|---|
| | Activity | Formula 10 | Formula 11 | Formula 12 | Formula 13 |
| DI Water | 100.00% | q/s to 100 | q/s to 100 | q/s to 100 | q/s to 100 |
| Laureth-6 plant based EO | 100.00% | 18.00 | 18.00 | 18.00 | 18.00 |
| Sodium Lauryl Sulfate | 29.00% | 30.00 | 30.00 | 30.00 | 30.00 |
| Glucose Diamine | 99.00% | 0.25 | 0.5 | 0.75 | 1 |
| ((2S,3R,5S,6R)-3-amino-6- | | | | | |
| (aminomethyl)oxane-2,5- | | | | | |
| diol) | | | | | |
| Anti-redeposition Polymer | 35.00% | 0.44 | 0.44 | 0.44 | 0.44 |
| EDDS Chelant (47% active), | 47.00% | 7.67 | 7.67 | 7.67 | 7.67 |
| Presevative (16% active), | | | | | |
| Anti-redeposition Polymer, | | | | | |
| Fatty Acid, Citric Acid (50%), | | | | | |
| and Sodium Hydroxide (50%, | | | | | |
| to adjust pH to 8) | | | | | |
| Protease, Amylase, | 100.00% | 1.50 | 1.50 | 1.50 | 1.50 |
| Mannanase | | | | | |

Further, exemplary high pH, non-enzymatic formulations are provided in Table 7, below.

TABLE 7

| | Raw Material | Formula 14 | | | |
|---|---|---|---|---|---|
| Component | Activity | (Standard) | Formula 15 | Formula 16 | Formula 17 |
| Water | 100% | q/s to 100 | q/s to 100 | q/s to 100 | q/s to 100 |
| Nonionic surfactant | Approximately | 17.14 | 17.14 | 17.14 | 17.14 |
| (fatty alcohol ethoxylate | 88% as a blend | | | | |
| C12-15 7EO) and Anionic | | | | | |
| surfactant | | | | | |
| (sodium laureth sulfate, | | | | | |
| 3EO) | | | | | |
| Anionic surfactant/ | 100% | 10.95 | 10.95 | 10.95 | 10.95 |
| Defoamer | | | | | |
| (coconut fatty acid derived | | | | | |
| from palm) and sodium | | | | | |
| carbonate and Optical | | | | | |
| Brightener and Anti- | | | | | |
| Redeposition Polymer and | | | | | |
| Preservative | | | | | |
| Chelating agent | 34% | 1.18 | 1.18 | 1.18 | 1.18 |
| (tetrasodium | | | | | |
| iminodisuccinate) | | | | | |
| Glucosamine HCl | 99% | — | 0.15 | — | — |
| Glucose Diamine | 99% | — | — | 0.15 | — |
| ((2S,3R,5S,6R)-3-amino-6- | | | | | |
| (aminomethyl)oxane-2,5- | | | | | |
| diol is a good placeholder) | | | | | |
| Sorbitol Amine | 99% | — | — | — | 0.15 |

Although the present invention and its objects, features and advantages have been described in detail, other embodiments are encompassed by the invention. All references cited herein are incorporate by reference in their entireties. Finally, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. A liquid detergent composition comprising:
a sugar amine in an amount ranging from about 0.01 to about 2 wt % of the detergent composition;
a fatty alcohol ethoxylate in an amount ranging from about 5 to about 30 wt % of the detergent composition;
an anionic surfactant in an amount ranging from about 5 to about 35 wt % of the detergent composition; and
water.

2. The detergent composition of claim 1, wherein the sugar amine is a sugar alcohol amine, sugar diamine, a salt thereof, or any combination of any of the foregoing.

3. The detergent composition of claim 1, wherein the sugar amine is sorbitol amine, glucosamine, a glucose diamine, a salt thereof, or any combination of any of the foregoing.

4. The detergent composition of claim 1, wherein the sugar amine is glucosamine HCl.

5. The detergent composition of claim 1, further comprising a sodium tetraborate.

6. The detergent composition of claim 1, wherein the fatty alcohol ethoxylate is laureth-6 ethylene oxide (EO).

7. The detergent composition of claim 1, further comprising at least one of strong base or weak acid.

8. The detergent composition of claim 1, wherein the pH of the detergent composition ranges from about 7 to about 9.

9. The detergent composition of claim 1, wherein the pH of the detergent composition ranges from about 9 to about 12.

10. The detergent composition of claim 1, wherein the anionic surfactant is a lauryl sulfate or a lauryl ether sulfate.

11. The detergent composition of claim 1, further comprising:
a fatty acid in an amount ranging from about 0.1 to about 1 wt % of the detergent composition;
an anti-redeposition polymer in an amount ranging from about 0.1 to about 1 wt % of the detergent composition;
a chelating agent in an amount ranging from about 1 to about 5 wt % of the detergent composition;
a preservative in an amount ranging from about 0.05 to about 2 wt % of the detergent composition; and
an aqueous enzyme comprising a protease, an amylase, and a mannanase, the aqueous enzyme being in an amount ranging from about 1 to about 3 wt % of the detergent composition.

12. The detergent composition of claim 11, wherein:
(i) the anti-redeposition polymer is an acrylic/styrene copolymer,
(ii) the chelating agent is N,N-bis (carboxymethyl)-L-glutamic acid tetrasodium salt, and
(iii) the preservative is a micro biocide, algicide, and/or fungicide.

13. The detergent composition of claim 1, wherein the sugar amine is in an amount ranging from about 0.25 to about 1 wt % of the detergent composition.

14. A method of cleaning laundry, the method comprising:
combining an amount of the detergent composition of claim 1 with an amount of water to form a diluted detergent composition having from about 0.1 grams to about 1 gram of the detergent composition per liter of water; and
cleaning the laundry using the diluted detergent composition.

15. A liquid detergent composition comprising:
a sugar amine in an amount ranging from about 0.01 to about 0.5 wt % of the detergent composition;
a mixture of a nonionic surfactant and an anionic surfactant, the mixture being in an amount ranging from about 3 to about 25 wt % of the detergent composition and having a nonionic surfactant to anionic surfactant ratio ranging from about 5:1 to about 1:5; and
water; wherein
the detergent composition has a pH ranging from about 9 to about 12, and
the detergent composition has a zein score of less than about 2%.

16. The detergent composition of claim 15, further comprising:
a defoamer;
sodium bicarbonate;
an optical brightener;
an anti-redeposition polymer; and
a preservative.

17. The detergent composition of claim 16, wherein the combined amount of the defoamer, the sodium bicarbonate, the optical brightener, the anti-redeposition polymer, and the preservative ranges from about 5 to about 15 wt % of the detergent composition.

18. The detergent composition of claim 15, wherein the sugar amine is glucosamine HCl, a glucose diamine, sorbitol amine, or any combination thereof.

19. The detergent composition of claim 15, wherein the sugar amine is in an amount ranging from about 0.1 to about 0.2 wt % of the detergent composition.

20. The detergent composition of claim 15, further comprising a chelating agent in an amount ranging from about 0.1 to about 3 wt % of the detergent composition.
